(19) United States
(12) Patent Application Publication
(10) Pub. No.: US 2013/0064050 A1
(43) Pub. Date: Mar. 14, 2013

(54) WATCH WITH EASILY REPLACEABLE COMPONENTS

(71) Applicant: Roberto CARDIN, PONTE DI BRENTA (IT)

(72) Inventor: Roberto CARDIN, PONTE DI BRENTA (IT)

(73) Assignee: CONCHIA SOCIETA' A RESPONSABILITA' LIMITATA, ROVOLON (IT)

(21) Appl. No.: 13/607,894

(22) Filed: Sep. 10, 2012

(30) Foreign Application Priority Data
Sep. 9, 2011 (IT) PD2011A000286

(51) Int. Cl. G04B 37/00

(52) U.S. Cl. 368/295

(57) ABSTRACT

A watch with easily replaceable components, comprising a case, a bezel which is contoured so as to surround the glass of the case, and a strap. The bezel is fixed reversibly to the case with snap-acting quick engagement/release elements. The bezel has, on opposite perimetric portions, pairs of symmetrical grooves which are open on the inner part of the bezel and are closed on the outer part of the bezel and are each adapted to receive by insertion one end of a pin for the engagement of the strap, each pin remaining closed between the two grooves that accommodate its ends and the case.

### BACKGROUND OF THE INVENTION

The need is currently felt increasingly, for both women and men, to be able to match with clothing of a certain color a watch that has colors and a finish that fit in well with the colors of their clothing.

In order to deal with this requirement, watches with easily replaceable components are currently known which comprise a case, shaped so as to accommodate the mechanism of the watch or the electronic board in the case of a digital watch, a bezel which is shaped so as to surround the glass of the case, and a strap, wherein the bezel and the strap can be removed by the user himself and can be replaced with others having a different visual impact.

The bezel itself can be an ornamental element, or ornamental elements can be mounted thereon, enhancing the beauty or value of the watch or making it possible to match it with clothing of a particular color.

For example, an annular mask having a particular ornamental and distinctive nature, or an annular mask made of a particular material, can be mounted on the bezel.

In currently known watches with easily replaceable components, the bezel is fixed reversibly to the case by means of screws that are simple and quick to remove and the strap is hinged by means of telescopic pins which can be shortened elastically and whose ends are inserted in corresponding holes defined in the case itself.

The packages with which these watches are sold generally comprise a plurality of bezels, a plurality of straps and tools for assembling and disassembling the bezel and the strap on the part of the buyer and user.

Although these watches are appreciated, they have a great limitation in having to use adapted tools to remove a component and mount another one that is technically equivalent but esthetically different.

Experience in fact teaches that the adapted tools for assembling and disassembling the parts are seldom kept tidily available by the user, and this often is a disincentive or hindrance for the user in performing replacement, especially when the user has limited time available to get dressed and therefore to wear the appropriately prepared watch.

### SUMMARY OF THE INVENTION

The aim of the present invention is to provide a watch with easily replaceable components that is capable of obviating the limitations of similar watches of a known type.

Within this aim, an object of the invention is to provide a watch in which the various modular parts can be disassembled and reassembled without resorting to any tool but just by using one's hands.

Another object of the invention is to provide a watch with easily replaceable components that is simple and intuitive to handle and therefore can be used even quickly during clothing selection by the user.

Another object of the invention is to provide a watch whose visual impact can be adapted rapidly to the item of clothing chosen by the user.

Another object of the invention is to provide a watch with easily replaceable components that can be manufactured with known systems and technologies.

This aim, as well as these and other objects which will become better apparent hereinafter, are achieved by a watch with easily replaceable components, comprising a case, a bezel which is contoured so as to surround the glass of the case, and a strap, characterized in that said bezel is fixed reversibly to said case with snap-acting quick engagement/release means, said bezel having, on opposite perimetric portions, pairs of symmetrical grooves which are open on the inner part of said bezel and are closed on the outer part of said bezel and are each adapted to receive by insertion one end of a pin for the engagement of the strap, each pin remaining closed between the two grooves that accommodate its ends and said case.

### BRIEF DESCRIPTION OF THE DRAWINGS

Further characteristics and advantages of the invention will become better apparent from the description of a preferred but not exclusive embodiment of the watch according to the invention, illustrated by way of non-limiting example in the accompanying drawings, wherein:

FIG. 1 is an overall perspective view of a watch according to the invention;

FIG. 2 is an exploded perspective view of the watch according to the invention;

FIG. 3 is a perspective view from below of a detail of the watch according to the invention;

FIG. 4 is a transverse sectional view of a detail of the watch in the assembled condition;

FIG. 5 is a view from below of the watch according to the invention;

FIG. 6 is a first partially sectional side view of the watch according to the invention;

FIG. 7 is a second partially sectional side view of the watch according to the invention;

FIGS. 8 and 9 are respectively an assembled view and an exploded view of another watch according to the invention;

FIG. 10 is a longitudinal sectional view of a detail of a watch according to FIGS. 8 and 9.

### DESCRIPTION OF THE PREFERRED EMBODIMENTS

With reference to the figures, a watch with easily replaceable components is generally designated by the reference numeral 10.

The watch 10 comprises a case 11, a bezel 12 which is contoured so as to surround the glass of the case 11, and a strap 13.

The case 11 is the part that contains the mechanism of the watch, or the electronic board in the case of a digital watch, and the corresponding battery, the dial, the dial protection glass and the other per se known usual details.

The bezel 12 is sized so as to accommodate internally the case 11.

The bezel 12 is fixed reversibly to the case 11 with snap-acting quick engagement/release means 14, described better hereinafter.

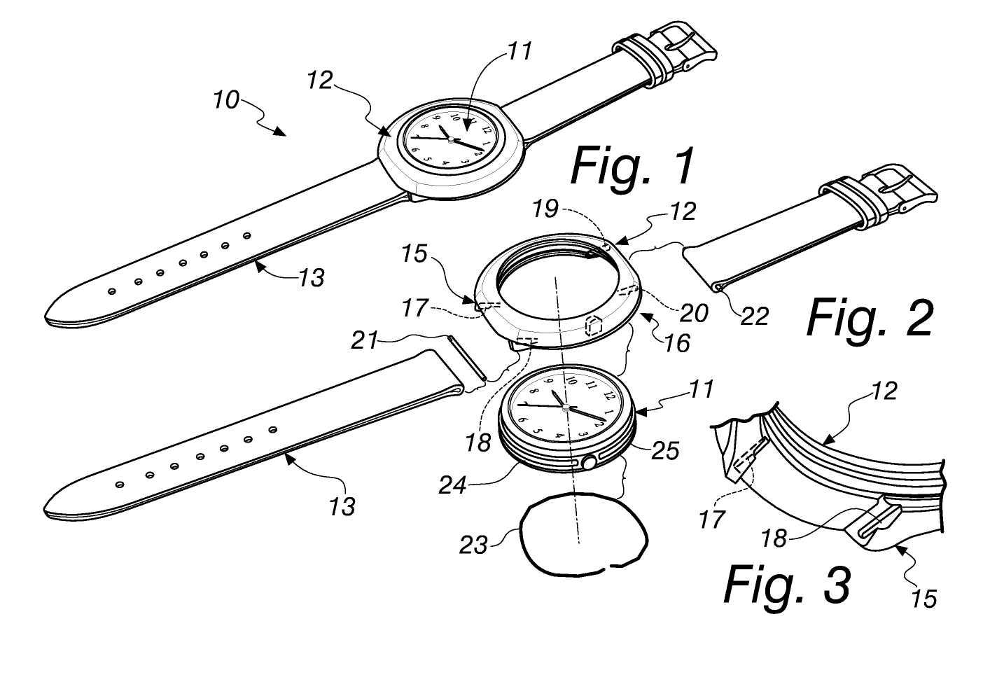

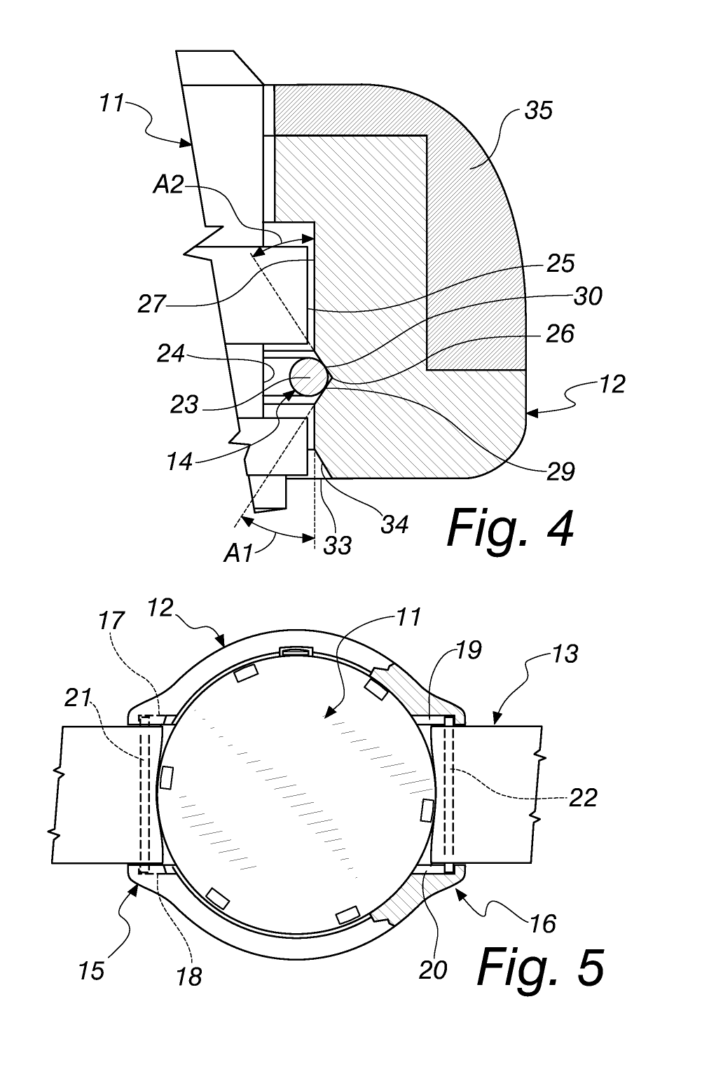

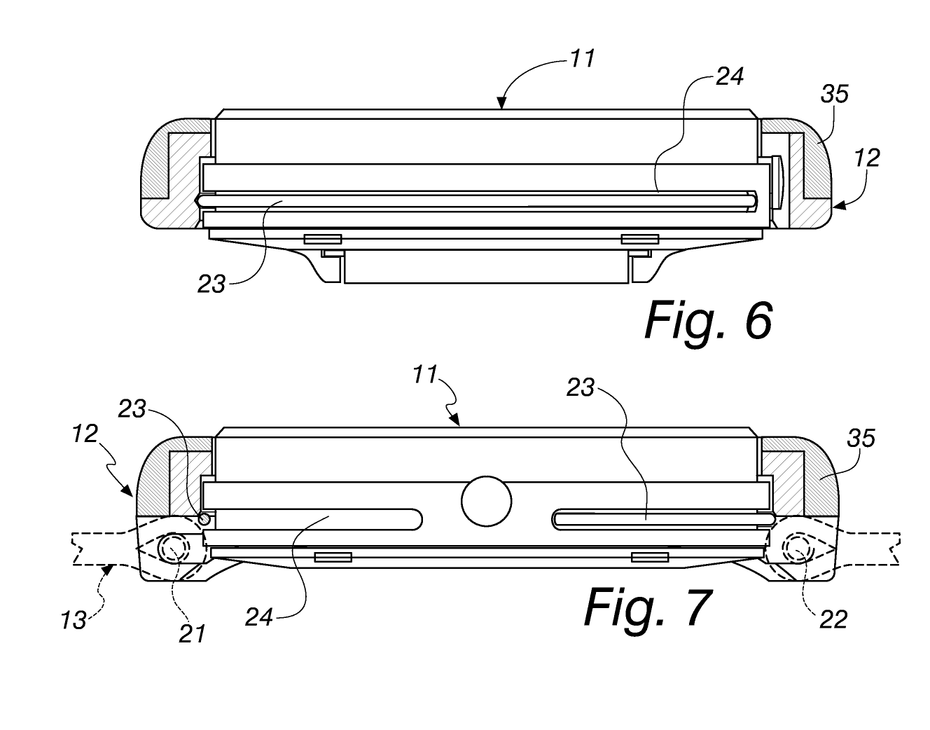

The bezel 12 has, on each one of two opposite perimetric portions 15 and 16, a pair of symmetrical grooves, respectively 17, 18 and 19, 20, which are clearly visible in FIGS. 2, 3 and 5, are open on the inner part of the bezel 12, are closed on the outer part of the bezel 12 and are each adapted to receive by insertion one end of a pin 21 or 22 for the engagement of the strap 13.

Each pin 21 and 22 remains closed and locked between the two grooves 17, 18 and 19, 20 that accommodate its ends and the case 11.

In the embodiment of the invention described here by way of non-limiting example of the invention, the snap-acting quick engagement/release means 14 are constituted by an elastic annular element 23, which is open or split, can be deformed elastically in a radial direction, is arranged so as to surround the case 11 and is partially accommodated in a corresponding annular slot 24 defined on the outer surface 25 of the case 11.

The elastic annular element 23 is substantially circumferential and can be provided with a continuous curvature or as a polygonal shape.

The elastic annular element 23 protrudes radially from the annular slot 24 and is available for snap engagement with a corresponding contoured slot 26 defined on the internal surface 27 of the bezel 12.

The contoured slot 26 has internal walls 29 and 30 that form, with the internal surface 27 of the bezel 12, corresponding acute angles A1, A2, which are adapted to facilitate the entry and exit of the elastic annular element 23 in the contoured slot 26.

The bezel 12 has a mouth 33 for the case 11 which has a beveled entry edge 34 adapted to interact with the elastic annular element 23, forcing it to deform radially, reducing its diameter temporarily.

Operation of the snap-acting quick engagement/release means is as follows.

To assemble the case 11 on a chosen bezel 12, one acts by placing the case 11 axially adjacent to the bezel 12 and applying enough pressure to make the elastic annular element 23 flex, making contact first with the beveled entry edge 34 to then slide on a portion of the internal surface 27 of the bezel 12 to then extend by snap action inside the contoured slot 26, causing the engagement of the case 11 and of the bezel 12.

Likewise, to perform the disengagement of the case 11 and of the bezel 12 it is necessary and sufficient to apply a certain pressure with the same axial orientation but in the opposite direction, so as to make the elastic annular element 23 protrude from the contoured slot 26.

Assembly and disassembly of the strap 13 are equally simple

When the case 11 and the bezel 12 are separate, the ends of the pins are extracted from the corresponding grooves to remove the strap 13 that is assembled and to insert the pins of the additional different strap to be assembled.

Once the pins have been inserted in the grooves, the engagement of the case 11 with the bezel 12 determines the extraction-preventing locking of the pins to the bezel 12.

Of course, it is understood that the bezel 12 itself can have an ornamental and distinctive character or can bear elements having an ornamental or distinctive character, such as for example an annular mask 35 made of natural or synthetic stone or colored plastic material or variously finished metallic material, or a mask in which one or more semiprecious and/or precious stones are set, or other solutions of combination of the cited possibilities, as well as other similar and equivalent ones.

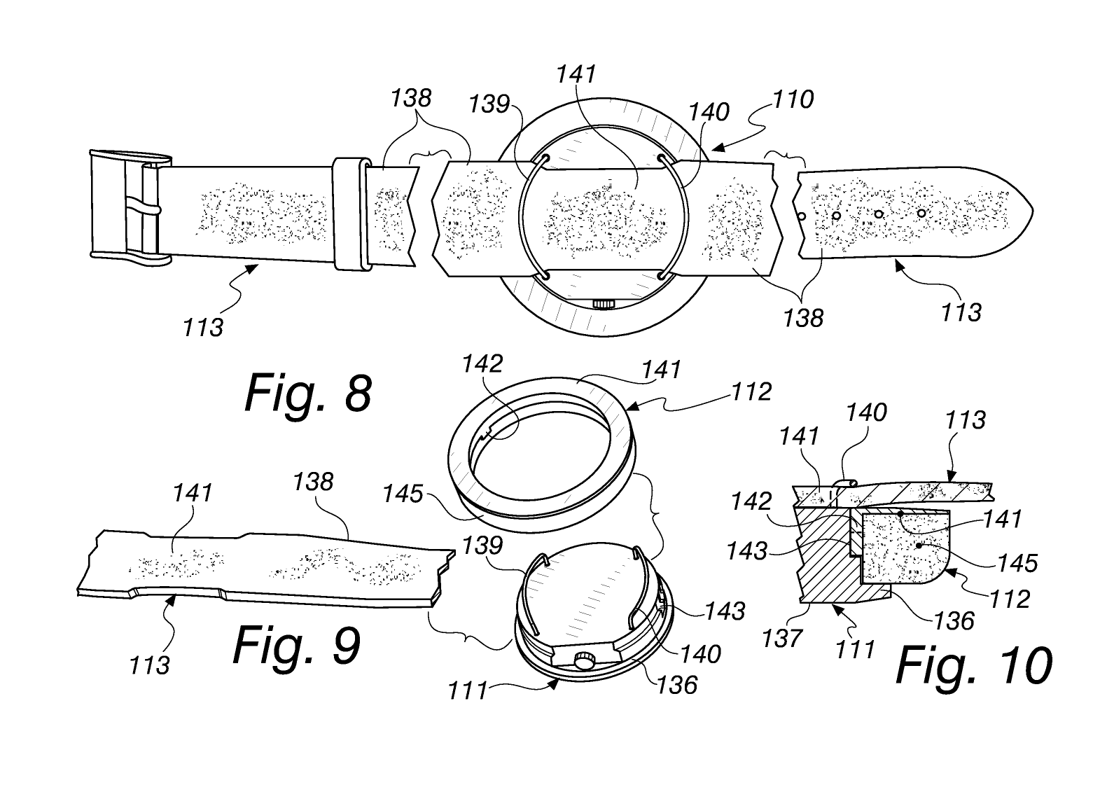

The invention also relates to a watch 110 with easily replaceable components, as shown in FIGS. 8 and 9.

The watch 110 comprises a case 111, a bezel 112 which is contoured so as to surround the glass of the case 111, and a strap 113, and is characterized in that the bezel 112 is coupled reversibly to the case 111 with quick locking/release means.

The quick locking/release means are defined

by an abutment portion 136, which expands radially from the case 111 perimetrically to the glass 137 of the case 111; the abutment portion 136 is adapted to define an annular resting region for the bezel 112,

and by the strap 113 itself, defined by a single body 138 that is predominantly longitudinally elongated and is intended to be inserted in two loops 139 and 140 located below the case 111; the strap 113 supports the case 111 and locks, with its central portion 141, the bezel 112 against the abutment portion 136.

The bezel 112 comprises an annular base support 141, which is provided with one or more raised centering portions 142, which are intended to enter corresponding recesses 143 defined on the case 111.

The annular body 145 is mounted on the annular base support 141 and is intended to have an esthetic and ornamental content.

In practice it has been found that the invention achieves the intended aim and objects.

In particular, the invention provides a watch in which the various modular parts can be disassembled and reassembled without resorting to any tool but only by using one's hands, by way of the snap-acting quick engagement and disengagement means, or by way of the quick locking/release means, whose use is indeed fully manual.

Moreover, the invention provides a watch with components that are easy to replace and is simple and intuitive to handle and therefore usable even quickly during the selection of clothing by the user.

Moreover, the invention provides a watch whose visual impact can be adapted quickly to the item of clothing chosen by the user.

Furthermore, the invention provides a watch in which it is understood that it is possible to replace the strap and the bezel but also the case itself, which can be replaced with another one having equal technical peculiarities but for example a different dial, different glass, et cetera.

Not least, the invention has provided a watch with easily replaceable components that can be manufactured with known systems and technologies.

The invention thus conceived is susceptible of numerous modifications and variations, all of which are within the scope of the appended claims. All the details may furthermore be replaced with other technically equivalent elements.

In practice, the materials used, as well as the contingent shapes and dimensions, may be any according to requirements and to the state of the art.

The disclosures in Italian Patent Application No. PD2011A000286 from which this application claims priority are incorporated herein by reference.

What is claimed is:

1. A watch with easily replaceable components, comprising a case, a bezel which is contoured so as to surround the glass of the case, and a strap, wherein said bezel is fixed reversibly to said case with snap-acting quick engagement/release means, said bezel having, on opposite perimetric portions, pairs of symmetrical grooves which are open on the inner part of said bezel and are closed on the outer part of said bezel and are each adapted to receive by insertion one end of a pin for the engagement of the strap, each pin remaining closed between the two grooves that accommodate its ends and said case.

2. The watch according to claim 1, wherein said snap-acting quick engagement/release means are constituted by an elastic annular element, which can be deformed elastically in a radial direction, is arranged so as to surround the case and is partially accommodated in a corresponding annular slot defined on the outer surface of said case, said elastic annular element protruding radially from the annular slot and being available for snap engagement with a corresponding contoured slot defined on the internal surface of the bezel.

3. The watch according to claim 2, wherein said contoured slot has internal walls that form, with the internal surface of the bezel, corresponding acute angles, which are adapted to facilitate the entry and exit of the elastic annular element from said contoured slot.

4. The watch according to claim 2, wherein said bezel has a mouth for the case which has a beveled entry edge adapted to interact with the elastic annular element, forcing it to deform radially, reducing its diameter temporarily.

5. The watch according to claim 1, wherein said bezel bears elements having an ornamental or distinctive character, such as an annular mask made of natural or synthetic stone or colored plastic material or variously finished metallic material, or a mask in which one or more semiprecious and/or precious stones are set, or other solutions of combination of the cited possibilities, as well as other similar and equivalent ones.

6. A watch with easily replaceable components, comprising a case, a bezel which is contoured so as to surround the glass of the case, and a strap, wherein said bezel is coupled reversibly to said case with quick locking/release means defined by an abutment portion, which expands radially from the case perimetrically to the glass of said case and is adapted to define one or more resting regions for said bezel, and by the strap itself, defined by a single body that is predominantly longitudinally elongated and is intended to be inserted in two loops located below said case, said strap supporting said case and locking, with its central portion, said bezel against said abutment portion.
